(19) United States
(12) Patent Application Publication
(10) Pub. No.: US 2019/0146835 A1
(43) Pub. Date: May 16, 2019

(54) IMPLEMENTING COGNITIVE DYNAMIC LOGICAL PROCESSOR OPTIMIZATION SERVICE

(71) Applicant: International Business Machines Corporation, Armonk, NY (US)

(72) Inventors: Ben Gibbs, Austin, TX (US); Riaz Hussain, Austin, TX (US); Lili Li, Cedar Park, TX (US); Zhichao Li, Austin, TX (US); Su Liu, Austin, TX (US); Rene Neumann, Austin, TX (US)

(21) Appl. No.: 15/810,397

(22) Filed: Nov. 13, 2017

(51) Int. Cl. G06F 9/48; G06F 9/50; G06F 11/30; G06F 11/34

(52) U.S. Cl. CPC G06F 9/4881; G06F 9/5083; G06F 2209/5018; G06F 11/3024; G06F 11/3409; G06F 9/505

(57) ABSTRACT

A method and computer system for implementing dynamic and cognitive central processing unit (CPU) optimization for systems with simultaneous multiple threading (SMT) based upon application performance and CPU usage. Performance of applications and CPU usage are monitored using a Cognitive Processor Manager (CPM) for reassigning the applications to different threads of each processor core responsive to the identified application performance and CPU usage.

### FIELD OF THE INVENTION

The present invention relates generally to the data processing field, and more particularly, relates to a method and computer system for implementing dynamic and cognitive central processing unit (CPU) optimization for systems with simultaneous multiple threading (SMT) based upon application performance and CPU usage.

### DESCRIPTION OF THE RELATED ART

CPU optimization for processors and processor cores designed with simultaneous multiple threading (SMT) hardware present challenges for thread usage control.

A need exists for an effective method and computer system for implementing dynamic and cognitive central processing unit (CPU) optimization for systems with simultaneous multiple threading (SMT) based upon application performance and CPU usage in order to minimize resource competition.

### SUMMARY OF THE INVENTION

Principal aspects of the present invention are to provide method and computer system for implementing dynamic and cognitive central processing unit (CPU) optimization for systems with simultaneous multiple threading (SMT) based upon application performance and CPU usage. Other important aspects of the present invention are to provide such method, and computer system substantially without negative effects and that overcome some of the disadvantages of prior art arrangements.

In brief, a method and computer system for implementing dynamic and cognitive central processing unit (CPU) optimization for systems with simultaneous multiple threading (SMT) based upon application performance and CPU usage. Performance of applications and CPU usage are monitored using a Cognitive Processor Manager (CPM) for reassigning the applications to different threads of each processor core responsive to the identified application performance and CPU usage.

In accordance with features of the invention, CPU optimization is performed using a kernel application by reassigning the applications to different threads of each processor core based upon the application performance and CPU usage.

In accordance with features of the invention, an enhanced performance is provided by recognizing application priority. An application level of importance is identified, for example, with predefined weights defined by the user, and choosing only one CPU as a primary, such that it is a highly utilized CPU.

In accordance with features of the invention, application performance behavior is based on application distribution on the logical processors.

### BRIEF DESCRIPTION OF THE DRAWINGS

The present invention together with the above and other objects and advantages may best be understood from the following detailed description of the preferred embodiments of the invention illustrated in the drawings, wherein:

FIG. 1 is a block diagram of an example computer system for implementing dynamic and cognitive central processing unit (CPU) optimization for systems with simultaneous multiple threading (SMT) based upon application performance and CPU usage in accordance with preferred embodiments;

FIG. 2A and 2B illustrates an example method for implementing dynamic and cognitive central processing unit (CPU) optimization for systems with simultaneous multiple threading (SMT) based upon application performance and CPU usage in accordance with a preferred embodiment;

FIG. 3 illustrates an example operational steps for managing application and logical processors of an example method for implementing dynamic and cognitive central processing unit (CPU) optimization for systems with simultaneous multiple threading (SMT) based upon application performance and CPU usage in accordance with a preferred embodiment; and

FIG. 4 is a block diagram illustrating a computer program product in accordance with the preferred embodiment.

### DETAILED DESCRIPTION OF THE PREFERRED EMBODIMENTS

In the following detailed description of embodiments of the invention, reference is made to the accompanying drawings, which illustrate example embodiments by which the invention may be practiced. It is to be understood that other embodiments may be utilized and structural changes may be made without departing from the scope of the invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

In accordance with features of the invention, a method and computer system are provided for implementing dynamic and cognitive central processing unit (CPU) optimization for systems with simultaneous multiple threading or simultaneous multiple threads (SMT) hardware based upon application performance and CPU usage.

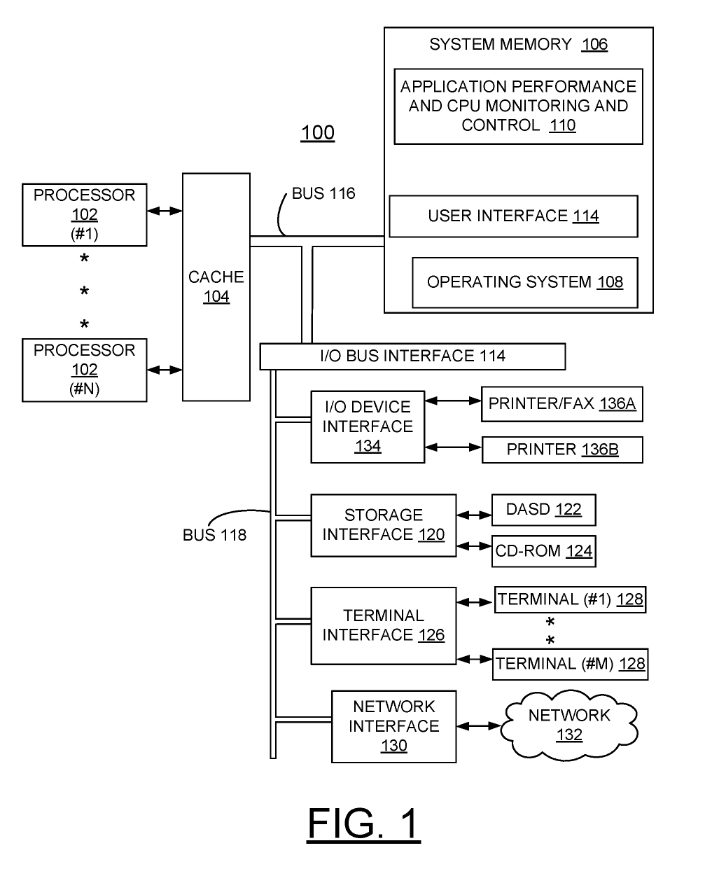

Having reference now to the drawings, in FIG. 1, there is shown an example computer system generally designated by the reference character 100 for implementing CPU optimization for systems with simultaneous multiple threading (SMT) in accordance with preferred embodiments. Computer system 100 includes one or more processors 102 or general-purpose programmable central processing units (CPUs) 102, #1-N. As shown, computer system 100 includes multiple processors 102 typical of a relatively large system; however, system 100 can include a single CPU 102. Computer system 100 includes a cache memory 104 connected to each processor 102.

Computer system 100 includes a system memory 106, an operating system 108, an application performance and CPU monitoring and control 110 in accordance with an embodiment of the invention and a user interface 112. System memory 106 is a random-access semiconductor memory for storing data, including programs. System memory 106 is comprised of, for example, a dynamic random access memory (DRAM), a synchronous direct random access memory (SDRAM), a current double data rate (DDRx) SDRAM, non-volatile memory, optical storage, and other storage devices.

I/O bus interface 114, and buses 116, 118 provide communication paths among the various system components. Bus 116 is a processor/memory bus, often referred to as front-side bus, providing a data communication path for transferring data among CPUs 102 and caches 104, system memory 106 and I/O bus interface unit 114. I/O bus interface 114 is further coupled to system I/O bus 118 for transferring data to and from various I/O units.

As shown, computer system 100 includes a storage interface 120 coupled to storage devices, such as, a direct access storage device (DASD) 122, and a CD-ROM 124. Computer system 100 includes a terminal interface 126 coupled to a plurality of terminals 128, #1-M, a network interface 130 coupled to a network 132, such as the Internet, local area or other networks, and a I/O device interface 134 coupled to I/O devices, such as a first printer/fax 136A, and a second printer 136B.

I/O bus interface 114 communicates with multiple I/O interface units 120, 126, 130, and 134, which are also known as I/O processors (IOPs) or I/O adapters (IOAs), through system I/O bus 116. System I/O bus 116 is, for example, an industry standard PCI bus, or other appropriate bus technology.

Computer system 100 may be, for example, an IBM® eServer™ System p® computer system, running the Advanced Interactive Executive (AIX®) operating system or the LINUX® operating system. Computer system 100 includes simultaneously executing hardware threads in simultaneous multiple threading (SMT) processors and SMT processor cores.

Computer system 100 is shown in simplified form sufficient for understanding the present invention. It should be understood that the present invention is not limited to the illustrated arrangement of computer system 100.

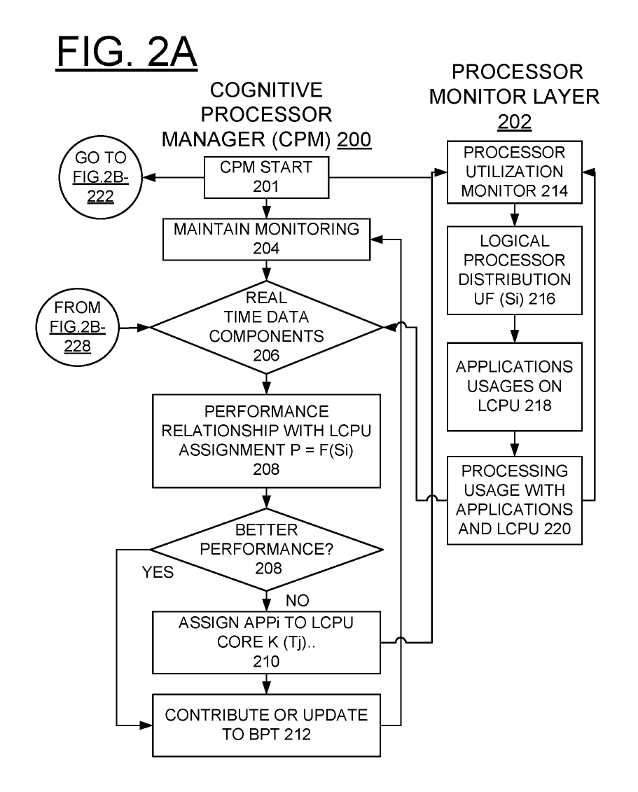

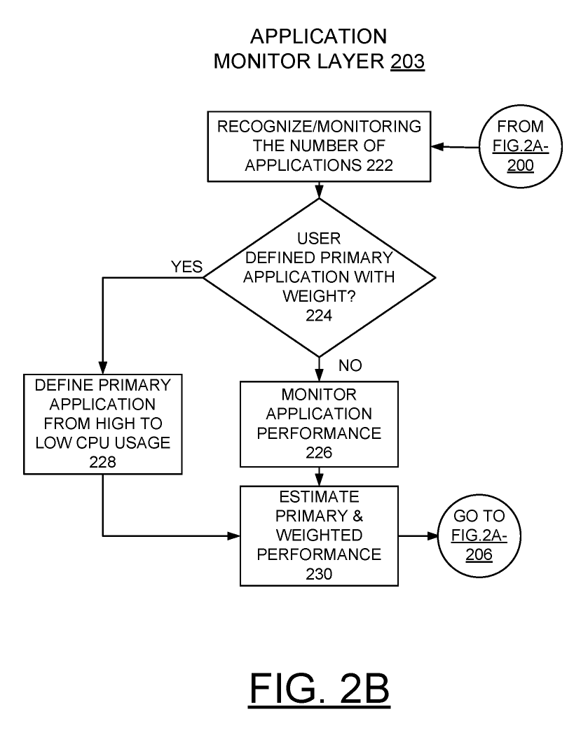

In accordance with features of the invention, Cognitive Processor Manager (CPM) 200 monitors all application performances and CPU usages, for example, as shown in FIGS. 2A, and 2B. The performance behavior is based on the application distribution on the logical processors.

In accordance with features of the invention, CPU logical processors are recognized between applications and system usage. The application importance information optionally either given by user, such as which is primary application expressed with weights, or system takes the importance equally or only choose one using highest CPU as primary by kernel.

Referring now to FIGS. 2A and 2B, there is shown an example method for implementing dynamic and cognitive central processing unit (CPU) optimization for systems with simultaneous multiple threading or threads (SMT) based upon application performance and CPU usage in accordance with a preferred embodiment. Dynamic and cognitive central processing unit (CPU) optimization includes operations of Cognitive Processor Manager (CPM) 200 starting at a block 201, processor monitor layer 202 in FIG. 2A, and application monitor layer 203 in FIG. 2B.

In FIG. 2A, CPM monitoring is maintained as indicated at a block 204. Real time data components are identified from the processor monitor layer 202 in FIG. 2A, and application monitor layer 203 in FIG. 2B as indicated at a decision block 206. Performance relationship with LCPU assignment P=F(Si). If more than one application, monitor if applications have competition on the same LCPUs based on the performance monitor module UF. Default application will be loaded on:

$$S ( app 1 ) = ( \begin{matrix}App 1 & 0 & 0 & 0 \\ App 1 & 0 & 0 & 0 \\ … & & & \\ App 1 & 0 & 0 & 0\end{matrix} )$$

$$S ( appi ) = ( \begin{matrix}Appi & 0 & 0 & 0 \\ Appi & 0 & 0 & 0 \\ … & & & \\ Appi & 0 & 0 & 0\end{matrix} )$$

The default performance P (S, UF) is identified, and the CPU utilization distribution is examined among cores and hardware thread examining the CPU performance monitor module UF and the CPU utilization on CPU hardware threads, j=1 . . . J, the number of SMT of each CPU core UL on the current application assignment S.

In accordance with features of the invention, when examining the CPU utilization matrix UF, optionally includes when the usage is not balance on all threads, reassigning the application to different thread of each core. The reassignment depends on number of applications and SMT numbers n at the beginning. If n=2, Cognitive Processor Manager (CPM) would assign the background application to the half of the LCPU with the 3rd and 4th thread of each core at the beginning. If n>2, CPM would assign the background application to the thread of each core. If n>number of SMT, the application would run on some cores instead of each core.

For example, with three applications, the primary application (with the highest weight) is provided to the primary thread of each core, the rest are assigned to all thread of each CPU core. For example, when app1 is the primary application, then app2 through appi will be assigned to other threads of each core starting from thread SMT/2+1. If SMT=4, start to assign from SMT/2+1=3, the 3rd thread, the 4th thread, then 2nd thread and the like, where:

$$S ( app 1 ) = ( \begin{matrix}App 1 & 0 & 0 & 0 \\ App 1 & 0 & 0 & 0 \\ … & & & \\ App 1 & 0 & 0 & 0\end{matrix} )$$

$$S ( appi ) = ( \begin{matrix}0 & 0 & Appi & 0 \\ 0 & 0 & Appi & 0 \\ … & & & \\ 0 & 0 & Appi & 0\end{matrix} )$$

$$S ( appi + 1 ) = ( \begin{matrix}0 & 0 & 0 & Appi + 1 \\ 0 & 0 & 0 & Appi + 1 \\ … & & & \\ 0 & 0 & 0 & Appi + 1\end{matrix} )$$

In accordance with features of the invention, when monitoring changes, CPU utilization and application performance, new performance gain is compared with previous template, such as P(S) vs. P(S+1). The comparing steps are continued to find the best performance template (BPT).

Checking for better performance is performed as indicated at a decision block 208. For example, method pool from previous solutions is searched using Best Performance Templates (BPT) (ΣP), with i applications, j cores and k SMT, to find the best solution of the collected solution templates. If BPT exits the templates, re-assign the application APPi to the LCPU, core K, thread (Tj) with BPT suggestion, for example, as indicated at a block 210. As indicated at a block 212, contribute or update to Best Performance Templates (BPT).

In FIG. 2A, processor monitor layer 202 provides monitors processor utilization starting as indicated at a block 214. Logical processor distribution UF (Si) is identified as indicated at a block 216. Application Si usages on LCPU is identified as indicated at a block 218. Processing usage with applications and LCPU is identified as indicated at a block 220, and applied to the real time data components at decision block 206.

In FIG. 2B, application monitoring layer 203, determines and starts monitoring how many applications on the systems as indicated at a block 222. Checking for user defined primary application with weight is performed as indicated at a decision block 224. Monitoring application performance is performed as indicated at a block 226. When user defined primary application with weight is identified at decision block 224, a primary application form high to low CPU usage is defined as indicated at a block 228. Primary and weighted performance is estimated as indicated at a block 230 from application performance monitoring block 226 or as defined at block 228, and applied to the real time data components at decision block 206 in FIG. 2A.

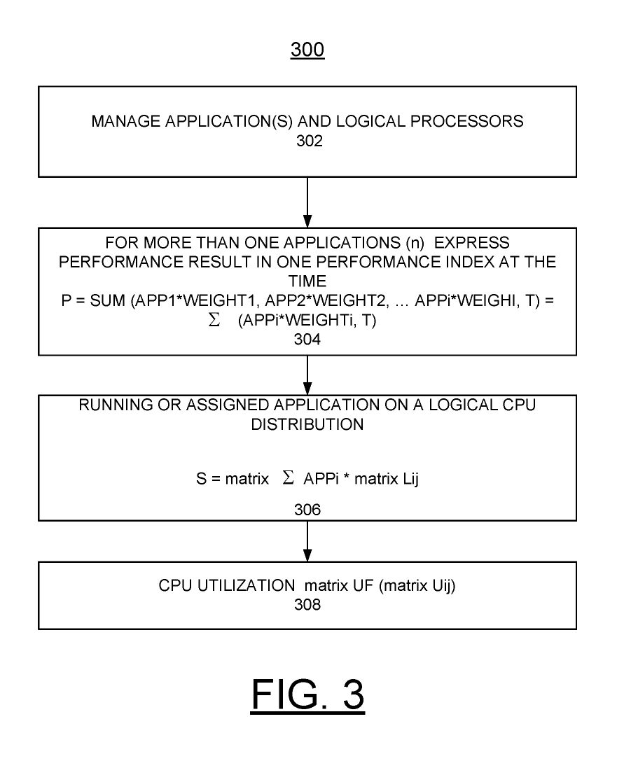

Referring now to FIG. 3, there is shown example operational steps 300 for cognitive dynamic tuning service an example method for implementing dynamic and cognitive central processing unit (CPU) optimization for systems with simultaneous multiple threads (SMT) based upon application performance and CPU usage in accordance with the preferred embodiment. As indicated at a block 302,

As indicated at a block 304, for several or more than on applications (n), performance result is expressed in one performance index at the time T, where

P=Sum (app1*weight1, app2* weight2, . . . appi*weighti, t)=Σ(appi*weighti, t)

where:

application label: i=1, 2 . . . n

Weight shows importance. Σ weight i=1

If only one primary app1 is considered and others are background application, weight 1=1, weight i=0.

As indicated at a block 306, an application is running or assigned on the logical CPU distribution, where:

$$S = Σ [ appi * ( \begin{matrix}\begin{matrix}Lij & … & Lij\end{matrix} \\ … \\ \begin{matrix}Lij & … & Lij\end{matrix}\end{matrix} ) ]$$

Lij=0 or 1, 1 means the application run on, 0 represent application i is not on the logical processor (LCPU)

i=1 . . . I, I the number of CPU cores, j=1 . . . J, J the number of simultaneous multiple threads (SMT)

As indicated at a block 308, CPU utilization matrix UF includes matrix Uij where:

$$UF = ( \begin{matrix}\begin{matrix}Uij & … & Uij\end{matrix} \\ … \\ \begin{matrix}Uij & … & Uij\end{matrix}\end{matrix} )$$

Logical CPU utilization in full matrix. I=1 . . . I, the number of CPU cores, J=1 . . . J , the number of SMT

If check the CPU utilization on CPU hardware threads. j=1 . . . J, the number of SMT of each CPU core

UL=(ΣUi1 . . . ΣUiJ)=(U1 . . . UJ)

For example, the example of 10 CPU with SMT=4. The assignment matrix is 10×4.

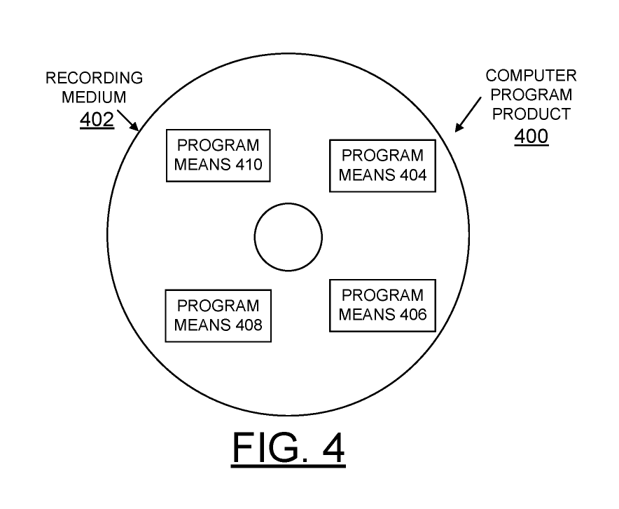

Referring now to FIG. 4, an article of manufacture or a computer program product 400 of the invention is illustrated. The computer program product 400 is tangibly embodied on a non-transitory computer readable storage medium that includes a non-transitory recording medium 402, such as, a floppy disk, a high capacity read only memory in the form of an optically read compact disk or CD-ROM, a tape, or another similar computer program product. Recording medium 402 stores program means 404, 406, 408, and 410 on the medium 402 for carrying out the methods for implementing dynamic and cognitive central processing unit (CPU) optimization in computer system 100 of FIG. 1.

A sequence of program instructions or a logical assembly of one or more interrelated modules defined by the recorded program means 404, 406, 408, and 410, direct the computer system 100 for implementing dynamic and cognitive central processing unit (CPU) optimization for computer systems with simultaneous multiple threading (SMT) including a processor and a Cognitive Processor Manager (CPM).

While the present invention has been described with reference to the details of the embodiments of the invention shown in the drawing, these details are not intended to limit the scope of the invention as claimed in the appended claims.

What is claimed is:

1. A computer-implemented method for implementing dynamic and cognitive central processing unit (CPU) optimization for computer systems with simultaneous multiple threading (SMT) including a processor and a Cognitive Processor Manager (CPM), said computer-implemented method comprising:
said Cognitive Processor Manager (CPM) monitoring application performance and CPU usage; and
reassigning applications to different threads of each processor core responsive to identified application performance and CPU usage.

2. The computer-implemented method as recited in claim 1 wherein said Cognitive Processor Manager (CPM) monitoring application performance and CPU usage includes identifying multiple applications and defining one performance index P at a time T.

3. The computer-implemented method as recited in claim 2 wherein performance index P at a time T is defined by a respective level of importance for applications identified with predefined weights.

4. The computer-implemented method as recited in claim 1 wherein said Cognitive Processor Manager (CPM) monitoring application performance and CPU usage includes identifying user assigned application importance information.

5. The computer-implemented method as recited in claim 1 wherein said Cognitive Processor Manager (CPM) monitoring application performance and CPU usage includes providing a kernel level application for automatically and cognitively identifying application performance and CPU usage.

6. The computer-implemented method as recited in claim 1 wherein said Cognitive Processor Manager (CPM) monitoring application performance and CPU usage includes monitoring application performance behavior based upon application distribution on CPU logical processors.

7. The computer-implemented method as recited in claim 6 includes recognizing CPU logical processors between applications and CPU usage.

8. The computer-implemented method as recited in claim 1 wherein said Cognitive Processor Manager (CPM) monitoring application performance and CPU usage includes identifying application importance information using a highest CPU as primary by a kernel level application.

9. The computer-implemented method as recited in claim 1 wherein said Cognitive Processor Manager (CPM) monitoring application performance and CPU usage includes maintaining best performance templates (BPT), monitoring application performance and CPU usage changes and comparing with said best performance templates (BPT).

10. A computer system for implementing dynamic and cognitive central processing unit (CPU) optimization for systems with simultaneous multiple threading (SMT) comprising:
a processor;
a Cognitive Processor Manager (CPM) monitoring application performance and CPU usage;
said processor using said Cognitive Processor Manager (CPM for reassigning applications to different threads of each processor core responsive to identified application performance and CPU usage.

11. The system as recited in claim 10 includes control code stored on a computer readable medium, and wherein said processor uses said control code for implementing dynamic and cognitive central processing unit (CPU) optimization.

12. The system as recited in claim 10 includes said Cognitive Processor Manager (CPM) determining a number of applications.

13. The system as recited in claim 10 includes said Cognitive Processor Manager (CPM) receiving a respective level of importance for multiple applications.

14. The system as recited in claim 10 includes said Cognitive Processor Manager (CPM) receiving real time data components from a performance monitor layer.

15. The system as recited in claim 10 includes said Cognitive Processor Manager (CPM) receiving real time data components from a processor monitor layer.

16. The system as recited in claim 10 includes said Cognitive Processor Manager (CPM) monitoring application performance behavior based upon application distribution on CPU logical processors.

17. The system as recited in claim 10 includes said Cognitive Processor Manager (CPM) identifying application importance information using a highest CPU as primary provided by a kernel level application.

18. The system as recited in claim 10 includes said Cognitive Processor Manager (CPM) identifying application importance information provided by a user.

19. The system as recited in claim 10 includes said Cognitive Processor Manager (CPM) maintaining best performance templates (BPT), monitoring application performance and CPU usage changes and comparing identified changes with said best performance templates (BPT).

20. The system as recited in claim 10 includes said Cognitive Processor Manager (CPM) maintaining best performance templates (BPT), and searching said best performance templates (BPT) for reassigning applications to different threads.
